(19) United States
(12) Patent Application Publication
(10) Pub. No.: US 2011/0047322 A1
(43) Pub. Date: Feb. 24, 2011

(54) METHODS, SYSTEMS AND DEVICES FOR INCREASING DATA RETENTION ON SOLID-STATE MASS STORAGE DEVICES

(75) Inventors: William J. Allen, Cupertino, CA (US); Franz Michael Schuette, Colorado Springs, CO (US)

Correspondence Address: HARTMAN & HARTMAN, P.C., 552 EAST 700 NORTH, VALPARAISO, IN, 46383, US

(73) Assignee: OCZ TECHNOLOGY GROUP, INC., San Jose, CA (US)

(21) Appl. No.: 12/859,557

(22) Filed: Aug. 19, 2010

Related U.S. Application Data
(60) Provisional application No. 61/235,100, filed on Aug. 19, 2009.

(51) Int. Cl. G06F 12/02; G06F 12/00

(52) U.S. Cl. 711/103; 711/E12.001; 711/E12.008

(57) ABSTRACT

Methods, systems and devices for increasing the reliability of solid state drives containing one or more NAND flash memory arrays. The methods, systems and devices take into account usage patterns that can be employed to initiate proactive scrubbing on demand, wherein the demand is automatically generated by a risk index that can be based on one or more of various factors that typically contribute to loss of data retention in NAND flash memory devices.

### CROSS REFERENCE TO RELATED APPLICATIONS

This application claims the benefit of U.S. Provisional Application No. 61/235,100, filed Aug. 19, 2009. The contents of this prior application are incorporated herein by reference.

### BACKGROUND OF THE INVENTION

The present invention generally relates to memory devices for use with computers and other processing apparatuses. More particularly, this invention relates to a nonvolatile or permanent memory-based mass storage device using background scrubbing to identify storage addresses that could potentially develop retention problems and proactively copy the data to a different location on the same device using idle periods.

Mass storage devices such as advanced technology (ATA) or small computer system interface (SCSI) drives are rapidly adopting nonvolatile memory technology such as flash memory or other emerging solid state memory technology including phase change memory (PCM), resistive random access memory (RRAM), magnetoresistive random access memory (MRAM), ferromagnetic random access memory (FRAM), organic memories, or nanotechnology-based storage media such as carbon nanofiber/nanotube-based substrates. The currently most common technology uses NAND flash memory as inexpensive storage memory.

Despite all its advantages with respect to speed and price, flash memory has the drawback of limited endurance and data retention caused by the physical properties of the floating gate, the charge of which defines the bit contents of each cell. Typical endurance for multilevel cell NAND flash is currently in the order of 10000 write cycles at 50 nm process technology and approximately 3000 write cycles at 4x nm process technology, and endurance is decreasing with every process node. Data retention is influenced by factors like temperature and number or frequency of accesses, wherein access can either be read or write The issue of frequency of accesses is not confined to a cell of interest that holds critical data, but can also encompass any cell in the physical proximity of that cell. In more detail, if a cell is accessed for a read, its floating gate charge may be altered slightly, but at the same time all other cells in the same block are subjected to an even higher exposure of electrical field which can potentially alter their contents. In the case of writes, which often also require an anteceding block-erase, the disturbance is even greater since both writing and erasing are very harsh processes, requiring exposure to extremely high electromagnetic fields to move electrons from or into the floating gate.

Similar to the case of write endurance, retention rates are progressively getting worse with smaller process geometries. This decreased data retention is related to a thinner tunnel oxide layer, which facilitates leakage currents. Moreover, proximity effects such as read disturb and stress-induced leakage current are becoming increasingly important with smaller process geometry because of the interaction of polarization fields as contributing factors for data leakage from the floating gate.

At present, there is no adequate predictability of when cells will start losing their data since operating temperature, changes in temperature, number of accesses, frequency of accesses and ratio between reads and writes influence the retention through interactions that are poorly understood and difficult to model. However, it is obvious that there is a need for some proactive measure to prevent data loss before it happens, and such measures should include the use of error checking and correction mechanisms to avoid or at least minimize the risk of catastrophic failures.

In mass storage systems, checking of data integrity during periods of no-transfers is generally referred to as disc scrubbing as described by Schwartz et al., Modeling, Analysis, and Simulation of Computer and Telecommunications Systems, Proceedings of the IEEE Computer Society's 12th Annual International Symposium, 409 (Oct. 4-8, 2004). The underlying principle is to use idle periods of drives to check for bad blocks and then rebuild the data in a different location. U.S. Pat. No. 5,632,012 to Belsan describes such a disk scrubbing system. U.S. Patent Application 2002/0162075 to Talagala describes disk scrubbing at the disk controller level wherein the disk controller reads back data during idle phases and generates a checksum that is compared to a previously stored checksum for the same data. Any disparity between the checksums of the area scanned is used to identify bad data and initiates rebuilding of the data at different addresses using redundancy mechanisms.

U.S. Pat. No. 6,292,869 to Gerchman et al. describes the interruption of self-timed refresh upon receiving a scrub command from the system to scrub memory arrays. U.S. Pat. No. 6,8408,063 by Rodeheffer teaches memory scrubbing of very large memory arrays using timer-based scan rates, wherein the scan rate can be defined depending on the requirements of the system.

None of the above references takes into account usage patterns that can be employed to initiate proactive scrubbing on demand.

### BRIEF SUMMARY OF THE INVENTION

The present invention provides methods, systems and devices for increasing the reliability of solid state drives containing one or more NAND flash memory arrays. The methods, systems and devices take into account usage patterns that can be employed to initiate proactive scrubbing on demand, wherein the demand is automatically generated by a risk index that can be based on one or more of various factors that typically contribute to loss of data retention in NAND flash memory devices.

According to a first aspect of the invention, a method is provided that includes logging timestamps of data writes to addresses of the NAND flash memory device, logging the number of read accesses of the data at the addresses, calculating a risk index based on the age of the data at the address, generating a risk warning if the risk index of the data at the address exceeds a predefined threshold, communicating the risk warning to a memory management unit of the mass storage device, issuing a copy command to copy the data at the address to a different address on the NAND flash memory device, and updating a file index of the mass storage device to reflect the different address of the data.

According to a second aspect of the invention, a method is provided that includes logging timestamps of data writes to first addresses of the NAND flash memory device, logging the number of read accesses of the data at the first addresses, calculating a primary risk index based on the age of the data at the first address, logging additional addresses of additional writes to the NAND flash memory device, generating a proximity value based on spatial relations between the first addresses and the additional addresses, generating a risk level map based on the proximity value, generating a secondary risk index of the data at the first address by combining the primary risk index with the risk level map, generating a risk warning if the secondary risk index exceeds a predefined threshold, communicating the risk warning to a memory management unit of the mass storage device, issuing a copy command to copy the data at the first address to a different address on the NAND flash memory device, and updating a file index of the mass storage device to reflect the different address of the data.

According to a third aspect of the invention, a system is provided that includes means for performing the steps of either method described

According to yet another aspect of the invention, the means for performing the steps of either method may be at system level or entirely contained within the mass storage device.

Objects and advantages of this invention will be better appreciated from the following detailed description.

### BRIEF DESCRIPTION OF THE DRAWINGS

FIG. 1 is a schematic representation of a mass storage device containing nonvolatile memory devices.

FIGS. 2 and 3 are flow diagrams representing processes for initiating on-demand proactive scrubbing of nonvolatile memory devices, such as shown in FIG. 1, in accordance with two embodiments of the present invention.

### DETAILED DESCRIPTION OF THE INVENTION

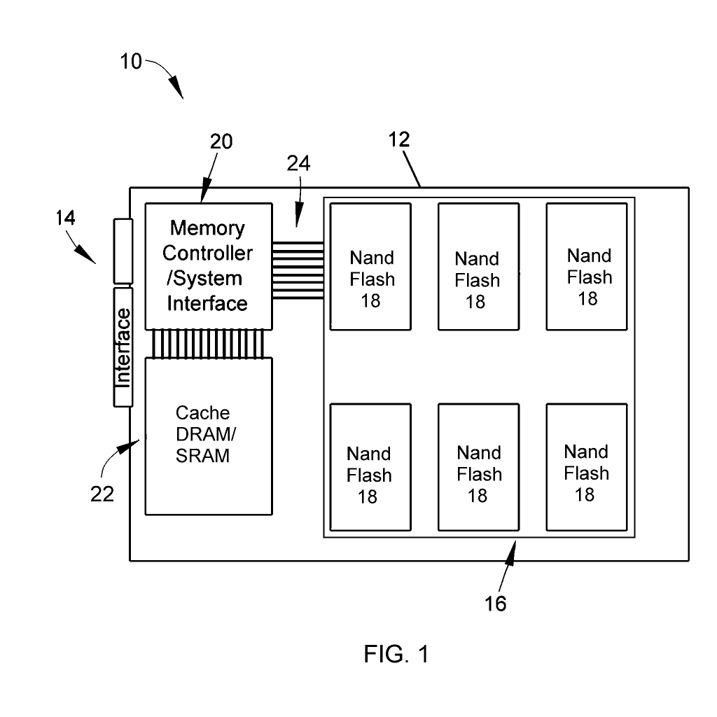

The present invention is generally applicable to computers and other processing apparatuses, and particularly to computers and apparatuses that utilize nonvolatile (permanent) memory-based mass storage devices, a notable example of which is mass storage devices that make use of NAND flash memory devices. FIG. 1 is schematically representative of such a mass storage device 10 of a type known in the art. The device 10 is represented as being configured as an internal mass storage device for a computer or other host system (processing apparatus) equipped with a data and control bus for interfacing with the mass storage device 10. The bus may operate with any suitable protocol in the art, preferred examples being the advanced technology attachment (ATA) bus in its parallel or serial iterations, fiber channel (FC), small computer system interface (SCSI), and serially attached SCSI (SAS).

As understood in the art, the mass storage device 10 is adapted to be accessed by a host system (not shown) with which it is interfaced. In FIG. 1, this interface is through a connector (host) interface 14 carried on a package 12 that defines the profile of the mass storage device 10. Access is initiated by the host system for the purposed of storing (writing) data to and retrieving (reading) data from an array 16 of solid-state nonvolatile memory devices 18 carried on the package 12. According to a preferred aspect of the invention represented in FIG. 1, the memory devices 18 are NAND flash memory devices 18, and allow data retrieval and storage in random access fashion using parallel channels 24. Data pass through a memory controller/system interface (controller) 20, for example, a system on a chip (SoC) device comprising a host bus interface decoder and a memory controller capable of addressing the array 16 of memory devices 18, as well as a volatile memory cache 22 integrated on the device 10. Protocol signals received through the interface 14 are translated by an abstraction layer of the controller 20 from logical to physical addresses on the memory devices 18 to which the data are written or from which they are read. The volatile memory cache 22 may be DRAM or SRAM-based, and may optionally be integrated into the controller 20, as known and understood in the art.

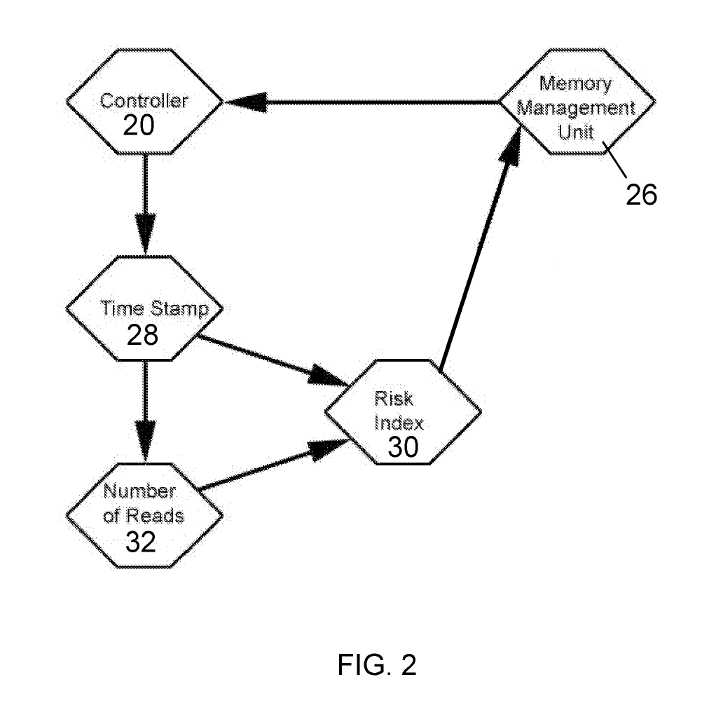

According to a preferred aspect of the invention, the reliability of the NAND flash memory devices 18 and their data is promoted through the use of a data management system and method that implements background scrubbing to identify storage addresses on the devices 18 that could potentially develop retention problems, and then proactively copy the data to a different location on the same device 18 during idle periods. In the preferred embodiment, the controller 20 is configured to perform memory management, represented in FIG. 2 as being performed by a memory management unit 26, which may also be within the abstraction layer of the controller 20. The memory management unit 26 is operable to initiate a global scrub request to the controller 20, which then scans individual blocks of each memory device 18 to determine the time when the data were written to the blocks, and then logs the timestamp 28 of data writes. In addition, the controller 20 may also log other information that can affect the reliability of the memory devices 18 and their data. For example, FIG. 2 further represents the controller 20 as checking the log for the number and frequency of reads 32 of each block. Other reliability-related information can also be collected by the controller 20. Such additional factors can include, but are not limited to, the number of erase cycles logged to any specific block as part of wear-leveling, and the number of bits that need to be corrected on any read. In particular, the number of errors and the change of this number between accesses is useful to determine the retention potential of any given block of data. Another factor contributing to write endurance and data retention is temperature. At high temperature, charges of the floating gates of NAND memory devices dissipate faster than at lower temperatures, resulting in decreased data retention. On the other hand, temperature cycling can be used to regenerate write endurance by releasing stuck electrons at broken bond sites. Therefore, it is advantageous to include the temperature history of the memory devices 18, including temperature fluctuations and general device temperature, as additional reliability-related information collected by the controller 20 to assess possible loss of data retention of a memory device 18.

FIG. 2 represents the controller 20 as compiling the age (timestamp 28) of each data entry and number of reads 32 (optionally along with the other reliability-related information) to generate a composite risk index for possible data corruption. A risk index unit 30 compiles the composite risk index and, if a predetermined threshold is exceeded for a given block of data, forwards a risk warning to the memory management unit 26. The memory management system 26 then issues a scrub request, by which the entire risk-warned block of data on the device 18 is scrubbed by copying the contents from the original physical address on the device 18 to a different physical address on the device 18, which receives the same logical address as the previous location. The memory management system 26 also updates the logical to physical translation so that the original pointer now points to the new physical address of the moved data. The risk-warned block of data at the original address can subsequently be erased in the background as a function of garbage collection. In this manner, the memory management system 26 is able to perform a preemptive scrubbing of data on the memory devices 18 based on the risk index 30.

While the process described above is described as being initiated and performed on the device controller level, the scrubbing operation can instead be initiated on the system level. In addition, the controller 20 or system can be configured to use back-up power during power-down states of the system to autonomously perform the scrubbing operation.

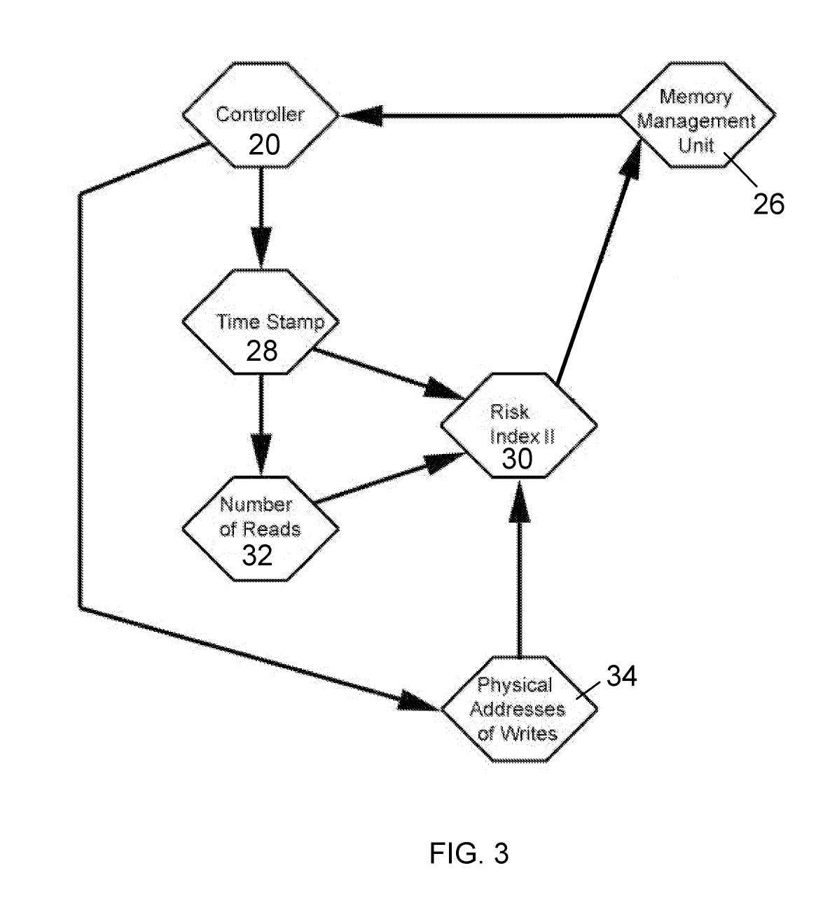

FIG. 3 schematically represents another embodiment for implementing a proactive scrub. For convenience, this implementation will also be described in reference to the mass storage device 10 of FIG. 1. The implementation of FIG. 3 primarily differs from that represented in FIG. 2 by further considering write accesses 34 to blocks of memory in proximity to a given block of data being assessed, from which a spatial risk level map of the array 16 can be generated, thereby taking into account increased risk of write disturbance. In this manner, the location and number of write accesses to neighboring physical memory addresses are additional reliability-related information that is collected by the controller 20 and taken into account to generate the risk index.

The controller 20 preferably tracks the write activity to all blocks of the memory devices 18 and performs an analysis to assess which memory blocks of each memory device 18 are close enough to be potentially affected by write activity on adjacent blocks. Depending on their distances from a block to which data are written, the risk levels of all blocks in proximity are increased to some degree. Because updating the data within the wear-leveling information of each block would require additional writes to those blocks and potentially lead to cascading write activity, a separate table is preferably utilized to store this information. This write-disturb information does not require ultimate granularity, but rather a high-level map of the physical block addresses may suffice to assign increased risk to particular areas of the memory devices 18. These areas, in turn, can be prioritized for scrubbing by combining the original risk index 30 with the write-disturb parameters to a secondary risk index.

While certain components and steps are represented and, in some cases, preferred for proactive scrubbing-enabled mass storage devices of the type described above, it is foreseeable that functionally-equivalent components could be used or subsequently developed to perform the intended functions of the disclosed components. Therefore, while the invention has been described in terms of a preferred embodiment, it is apparent that other forms could be adopted by one skilled in the art, and the scope of the invention is to be limited only by the following claims.

1. A method of increasing reliability of at least one NAND flash memory device of a mass storage device, the method comprising:
logging timestamps of data writes to addresses of the NAND flash memory device;
logging the number of read accesses of the data at the addresses;
calculating a risk index based on the age of the data at the address;
generating a risk warning if the risk index of the data at the address exceeds a predefined threshold;
communicating the risk warning to a memory management unit of the mass storage device;
issuing a copy command to copy the data at the address to a different address on the NAND flash memory device; and
updating a file index of the mass storage device to reflect the different address of the data.

2. The method of claim 1, wherein the risk index is further calculated based on the number of read accesses of the data at the address.

3. The method of claims 1, wherein the risk index is further calculated based on the number of corrected bits on each read of the data at the address.

4. The method of claims 1, wherein the risk index is further calculated based on the temperature history of the NAND flash memory device.

5. The method of claim 1, wherein the logging and calculating steps are performed at system level of a system containing the mass storage device.

6. The method of claim 1, wherein all steps of the method are performed on the mass storage device and independent of a system containing the mass storage device.

7. A method of increasing reliability of at least one NAND flash memory device of a mass storage device, the method comprising:
logging timestamps of data writes to first addresses of the NAND flash memory device;
logging the number of read accesses of the data at the first addresses;
calculating a primary risk index based on the age of the data at the first address;
logging additional addresses of additional writes to the NAND flash memory device;
generating a proximity value based on spatial relations between the first addresses and the additional addresses;
generating a risk level map based on the proximity value;
generating a secondary risk index of the data at the first address by combining the primary risk index with the risk level map;
generating a risk warning if the secondary risk index exceeds a predefined threshold;
communicating the risk warning to a memory management unit of the mass storage device;
issuing a copy command to copy the data at the first address to a different address on the NAND flash memory device; and
updating a file index of the mass storage device to reflect the different address of the data.

8. The method of claim 7, wherein the primary risk index is further calculated based on the number of read accesses of the data at the first address.

9. The method of claims 7, wherein the primary risk index is further calculated based on the number of corrected bits on each read of the data at the first address.

10. The method of claim 7, wherein the primary risk index is further calculated based on the number of erase cycles on each of the data at the first address.

11. The method of claims 7, wherein the primary risk index is further calculated based on the temperature history of the NAND flash memory device.

12. The method of claim 7, wherein the logging and calculating steps are performed at system level of a system containing the mass storage device.

13. The method of claim 7, wherein all steps of the method are performed on the mass storage device and independent of a system containing the mass storage device.

14. A computer system configured to increase reliability of at least one NAND flash memory device of a mass storage device of the system, the system comprising:
means for logging timestamps of data writes to addresses of the NAND flash memory device;
means for logging the number of read accesses of the data at the addresses;
means for calculating a risk index based on the age of the data at the address;
means for generating a risk warning if the risk index of the data at the address exceeds a predefined threshold;
means for communicating the risk warning to a memory management unit of the mass storage device;
means for issuing a copy command to copy the data at the address to a different address on the NAND flash memory device; and
means for updating a file index of the mass storage device to reflect the different address of the data.

15. The computer system of claim 14, wherein the calculating means further calculates the risk index based on the number of read accesses of the data at the address.

16. The computer system of claim 14, wherein the calculating means further calculates the risk index based on the number of corrected bits on each read of the data at the address.

17. The computer system of claim 14, wherein the calculating means further calculates the risk index based on the temperature history of the NAND flash memory device.

18. The computer system of claim 14, wherein the logging and calculating means are performed by components of the system apart from the mass storage device.

19. The computer system of claim 14, wherein the logging means, calculating means, generating means, communicating means, issuing means, and updating means are performed by components of the mass storage device.

20. The mass storage device of claim 19.
